(19) United States
(12) Patent Application Publication
(10) Pub. No.: US 2021/0053344 A1
(43) Pub. Date: Feb. 25, 2021

(54) FLUIDIC DIE WITH MONITORING CIRCUIT USING FLOATING POWER NODE

(71) Applicant: Hewlett-Packard Development Company, L.P., Spring, TX (US)

(72) Inventors: Eric Martin, Corvallis, OR (US); Rogelio Cicili, San Diego, CA (US)

(73) Assignee: Hewlett-Packard Development Company, L.P., Spring, TX (US)

(21) Appl. No.: 16/978,218

(22) PCT Filed: May 15, 2018
(86) PCT No.: PCT/US2018/032798

§ 371 Date: Sep. 4, 2020

(51) Int. Cl. B41J 2/045

(52) U.S. Cl. CPC B41J 2/04541; B41J 2/04586

(57) ABSTRACT

A fluidic die includes a high-side switch to selectively couple a power node to a power source, a pulldown switch to selectively couple the power node to a first reference voltage, a group of fluid actuators, each fluid actuator connected to the power node and each having a corresponding low-side switch to selectively couple the fluid actuator to a second reference voltage, and a group of fluid chambers, each including an electrode exposed to an interior of the fluid chamber, and each corresponding to a different one of the fluid actuators. Monitoring circuitry, during a monitoring operation, with the high-side switch and each low-side switch open, to connect to the electrode of a selected one of the fluid chambers, and to open the pulldown switch so that the fluid actuators are floating.

### BACKGROUND

Fluidic dies may include an array of nozzles and/or pumps each including a fluid chamber and a fluid actuator, where the fluid actuator may be actuated to cause displacement of fluid within the chamber. Some example fluidic dies may be printheads, where the fluid may correspond to ink.

### BRIEF DESCRIPTION OF THE DRAWINGS

FIG. 1 is a block and schematic diagram illustrating a fluidic die, according to one example.

FIG. 2 is a block and schematic diagram illustrating a fluidic die, according to one example.

FIG. 3 is a flow diagram generally illustrating a method of monitoring fluid chambers of a fluidic die, according to one example.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Examples of fluidic dies may include fluid actuators. The fluid actuators may include thermal resistor based actuators, piezoelectric membrane based actuators, electrostatic membrane actuators, mechanical/impact driven membrane actuators, magneto-strictive drive actuators, or other suitable devices that may cause displacement of fluid in response to electrical actuation. Fluidic dies described herein may include a plurality of fluid actuators, which may be referred to as an array of fluid actuators. An actuation event or firing event, as used herein, may refer to singular or concurrent actuation of fluid actuators of the fluidic die to cause fluid displacement.

In example fluidic dies, the array of fluid actuators may be arranged in sets of fluid actuators, where each such set of fluid actuators may be referred to as a “primitive” or a “firing primitive.” The number of fluid actuators in a primitive may be referred to as a size of the primitive. The set of fluid actuators of a primitive generally have a set of actuation addresses with each fluid actuator corresponding to a different actuation address of the set of actuation addresses. In some examples, electrical and fluidic constraints of a fluidic die may limit which fluid actuators of each primitive may be actuated concurrently for a given actuation event. Primitives facilitate addressing and subsequent actuation of fluid actuator subsets that may be concurrently actuated for a given actuation event to conform to such constraints.

To illustrate by way of example, if a fluidic die comprises four primitives, with each primitive including eight fluid actuators (with each fluid actuator corresponding to different one of the addresses 0 to 7), and where electrical and fluidic constraints limit actuation to one fluid actuator per primitive, a total of four fluid actuators (one from each primitive) may be concurrently actuated for a given actuation event. For example, for a first actuation event, the respective fluid actuator of each primitive corresponding to address “0” may be actuated. For a second actuation event, the respective fluid actuator of each primitive corresponding to address “5” may be actuated. As will be appreciated, the example is provided merely for illustration purposes, such that fluidic dies contemplated herein may comprise more or fewer fluid actuators per primitive and more or fewer primitives per die.

Example fluidic dies may include fluid chambers, orifices, and/or other features which may be defined by surfaces fabricated in a substrate of the fluidic die by etching, microfabrication (e.g., photolithography), micromachining processes, or other suitable processes or combinations thereof. Some example substrates may include silicon based substrates, glass based substrates, gallium arsenide based substrates, and/or other such suitable types of substrates for microfabricated devices and structures. As used herein, fluid chambers may include ejection chambers in fluidic communication with nozzle orifices from which fluid may be ejected, and fluidic channels through which fluid may be conveyed. In some examples, fluidic channels may be microfluidic channels where, as used herein, a microfluidic channel may correspond to a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.).

In some examples, a fluid actuator may be arranged as part of a nozzle where, in addition to the fluid actuator, the nozzle includes an ejection chamber in fluidic communication with a nozzle orifice. The fluid actuator is positioned relative to the fluid chamber such that actuation of the fluid actuator causes displacement of fluid within the fluid chamber that may cause ejection of a fluid drop from the fluid chamber via the nozzle orifice. Accordingly, a fluid actuator arranged as part of a nozzle may sometimes be referred to as a fluid ejector or an ejecting actuator.

In one example nozzle, the fluid actuator comprises a thermal actuator which is spaced from the fluid chamber by an insulating layer, where actuation (sometimes referred to as “firing”) of the fluid actuator heats the fluid to form a gaseous drive bubble within the fluid chamber that may cause a fluid drop to be ejected from the nozzle orifice, after which the drive bubble collapses. In some examples, a cavitation plate is disposed within the fluid chamber so as to be above the fluid actuator and in contact with the fluid within the chamber, where the cavitation plate protects material underlying the fluid chamber, including the underlying insulating material and fluid actuator, from cavitation forces resulting from generation and collapse of the drive bubble. In examples, the cavitation plate may be metal (e.g., tantalum).

In some examples, a fluid actuator may be arranged as part of a pump where, in addition to the fluidic actuator, the pump includes a fluidic channel. The fluidic actuator is positioned relative to a fluidic channel such that actuation of the fluid actuator generates fluid displacement in the fluid channel (e.g., a microfluidic channel) to convey fluid within the fluidic die, such as between a fluid supply (e.g., fluid slot) and a nozzle, for instance. A fluid actuator arranged to convey fluid within a fluidic channel may sometimes be referred to as a non-ejecting actuator. In some examples, similar to that described above with respect to a nozzle, a metal cavitation plate may be disposed within the fluidic channel above the fluid actuator to protect the fluidic actuator and underlying materials from cavitation forces resulting from generation and collapse of drive bubbles within the fluidic channel.

Fluidic dies may include an array of fluid actuators (such as columns of fluid actuators), where the fluid actuators of the array may be arranged as fluid ejectors (i.e., having corresponding fluid ejection chambers with nozzle orifices) and/or pumps (having corresponding fluid channels), with selective operation of fluid ejectors causing fluid drop ejection and selective operation of pumps causing fluid displacement within the fluidic die. In some examples, the array of fluid actuators may be arranged into primitives.

During operation of the fluidic die, conditions may arise that adversely affect the ability of nozzles to properly eject fluid drops and pumps to properly convey fluid within the die. For example, a blockage may occur in a nozzle orifice, ejection chamber, or fluidic channel, fluid (or components thereof) may become solidified on surfaces within a fluid chamber, such as on a cavitation plate, or a fluid actuator may not be functioning properly.

To determine when such conditions are present, techniques have been developed to measure various operating parameters (e.g., impedance, resistance, current, voltage) of nozzles and pumps using a sense electrode which is disposed so as to be exposed to an interior of the fluid chamber. In one case, in addition to protecting fluid actuators and other elements from cavitation forces, cavitation plates may also serve as sense electrodes. In one example, the sense electrode may be used to measure an impedance of fluid within the chamber when the nozzle and/or pump is inactive (i.e., not being fired), where such impedance may be correlated to a temperature of the fluid, fluid composition, particle concentration, and a presence of air, among others, for instance.

Drive bubble detect (DBD) is one technique which measures parameters indicative of the formation and collapse of a drive bubble within a fluid chamber to determine whether a nozzle or pump is defective (i.e. not operating properly). In one example, for a given fluid chamber, during an actuation event, a high-voltage (e.g., 32 V) is applied to the corresponding fluid actuator to vaporize at least one component of a fluid (e.g., water) to form a drive bubble within the fluid chamber. In one example, at one or more selected times after a fluid actuator has been fired (e.g., after start of expected formation but before collapse of the drive bubble), low-voltage (e.g., 5 V) DBD monitoring circuitry on the fluidic die selectively couples to the cavitation plate within the fluid chamber. In one example, the DBD monitoring circuitry provides a current pulse to the electrically conductive cavitation plate which flows through an impedance path formed by fluid and/or gaseous material of the drive bubble within the ejection chamber to a ground point. Based on the current pulse (e.g. based on a resulting voltage across the chamber), the DBD monitoring circuitry measures an impedance of the fluid chamber which indicative of the operating condition of the nozzle or pump (e.g., the nozzle/pump is operating properly, a nozzle orifice is plugged, etc.).

The impedance measured by fluid chamber monitoring circuitry (such as DBD monitoring circuitry) includes several fixed impedance components and a variable impedance component in the form of fluid within the fluid chamber. According to one example, the fixed impedance components include, among others, a parasitic resistance formed by the electrode (e.g., the cavitation plate) and connections between the monitoring circuit and the electrode, and a capacitance between circuit elements (e.g., conductors) connecting the monitoring circuit and a substrate or conductive layers adjacent to such circuit elements, and a capacitance between the cavitation plate and the fluid actuator. To improve an effectiveness of the impedance measurements by the monitoring circuitry and more accurately identify operating conditions of fluid chambers, it is desirable to minimize an amount of a measured impedance value represented by the fixed impedance components.

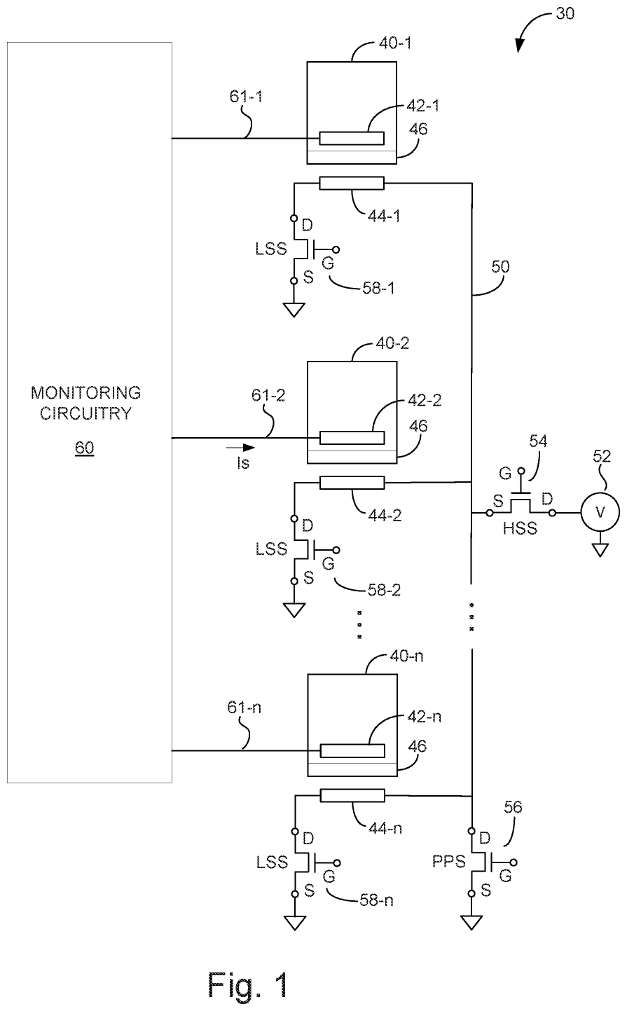

FIG. 1 is a block and schematic diagram generally illustrating a fluidic die 30, according to one example of the present disclosure, including monitoring circuitry for monitoring a condition of one or more fluid chambers via an impedance measurement, where the monitoring circuitry operates to eliminate a fixed impedance (e.g., a parasitic capacitance) which would otherwise be formed by an electrode within an interior of the fluid chamber (e.g., a cavitation plate) and a corresponding fluid actuator. By reducing fixed impedances, a variable impedance representing fluid within the fluid chamber, forms a larger portion of an overall impedance measured by the monitoring circuitry and thereby improves an effectiveness of the monitoring circuitry in determining operating conditions of the fluid chambers.

In one example, fluidic die 30 includes a plurality of fluid chambers 40 (illustrated as fluid chambers 40-1 to 40-n), with each chamber including an electrode 42 (illustrated as electrodes 42-1 to 42-n) disposed therein. In one example, electrode 42 comprises a cavitation plate 42 disposed at a bottom of fluid chamber 40. Each fluid chamber 42 has a corresponding fluid actuator 44 (illustrated as fluid actuators 44-1 to 44-n) which is separated from the fluid chamber 40 and electrode 42, such as by an insulating material 46 (e.g., an oxide layer). In one example, fluid actuators 44 operate at a high voltage (e.g., 32 volts) and, when actuated, may cause vaporization of fluid within fluid chamber 40 to form a drive bubble therein. In the case of a nozzle, where fluid chamber 40 is in fluidic communication with a nozzle orifice, formation of a drive bubble via actuation of fluid actuator 44 may cause ejection of a fluid drop (e.g., ink) from fluid chamber 40 via the nozzle orifice. In a case where fluid chamber 40 is a pump, formation of a drive bubble by actuation of fluid actuator 44 may cause conveyance of fluid within fluidic die 30 (e.g., to/from a nozzle).

In one example, fluid die 30 includes a power node 50 which is selectively connected to a power source 52 by a high-side switch (HSS) 54, and is selectively connected to a reference voltage (e.g., ground) via a pulldown switch (PS) 56. In one example, each fluid actuator 44 is connected at one end to power node 50 and is connected at the other end to a reference voltage (e.g., ground) via a corresponding low-side switch (LSS) 58, illustrated as low-side switches 58-1 to 58-n. In one case, PS 56 may connect power node 50 to a first reference voltage, and each LSS 52 may connect the corresponding fluid actuator 44 to a second reference voltage, which is different from the first reference voltage. In one example, the first and second reference voltages are the same.

In one example, fluidic die 30 includes monitoring circuitry 60 for monitoring an operating condition of each of the plurality of fluid chambers 40. In one example, monitoring circuitry 60 is electrically connected to cavitation plate 42 of each fluid chamber 40 via a connection element 61, illustrated as connection elements 61-1 to 61-n.

In one example, when all fluid actuators 44 are inactive (i.e., not being actuated or fired), HSS switch 54 is maintained in open position (disabled) to disconnect power node 50 from power source 52, each LSS switch 58 is maintained in an open position (disabled) to disconnect the corresponding fluid actuator 44 from the reference voltage, and PS 56 is maintained in a closed position (enabled) to hold power node 50 at a known (safe) reference voltage (e.g., ground).

According to one example, monitoring circuitry 60 performs monitoring operations of fluid chambers 40-1 to 40-n when all fluid actuators 44-1 to 44-n connected to power node 50 are inactive, such that HHS 54 and each of the LSS switches 58-1 to 58-n are open. In one example, during a monitoring operation, monitoring circuitry 60 selectively connects to a cavitation plate 42 of a selected fluid chamber 40 via a conductive element 61, and opens PS 56 to disconnect power node 50 from the reference voltage so that power node 50 and each fluid actuator 44 are “floating” (i.e., electrically disconnected from any electrical potential).

In one example, as will be described in greater detail below, monitoring circuitry 60 then provides a sense current to the cavitation plate 42 of the selected fluid chamber 44, such as sense current, I_{S}, being provided to cavitation 42-2 of selected fluid chamber 40-2, as illustrated in FIG. 1. According to one example, monitoring circuitry 60 determines an impedance based on a voltage generated across the selected chamber in response to the sense current, I_{S}, where such impedance is indicative of an operating condition of the selected fluid chamber. In one example, upon completion of a monitoring operation, monitoring circuitry 60 decouples from cavitation plate 42 of the selected fluid chamber 44 and closes (enables) PS 56 to connect power node 50 to the reference voltage.

By opening PS 56 so that fluid actuators 44 are “floating” during a monitoring operation of a selected fluid chamber 40 by monitoring circuitry 60, a parasitic capacitance that would otherwise be formed between the cavitation plate 42 of the selected fluid chamber 40 and the corresponding fluid actuator 44 is reduced. By reducing such fixed parasitic capacitance, a variable impedance representing an impedance of the selected fluid chamber 40 forms a greater portion of an overall impedance measured by monitoring circuitry 60 and improves an effectiveness and accuracy in determining an operating condition of the selected fluid chamber 40.

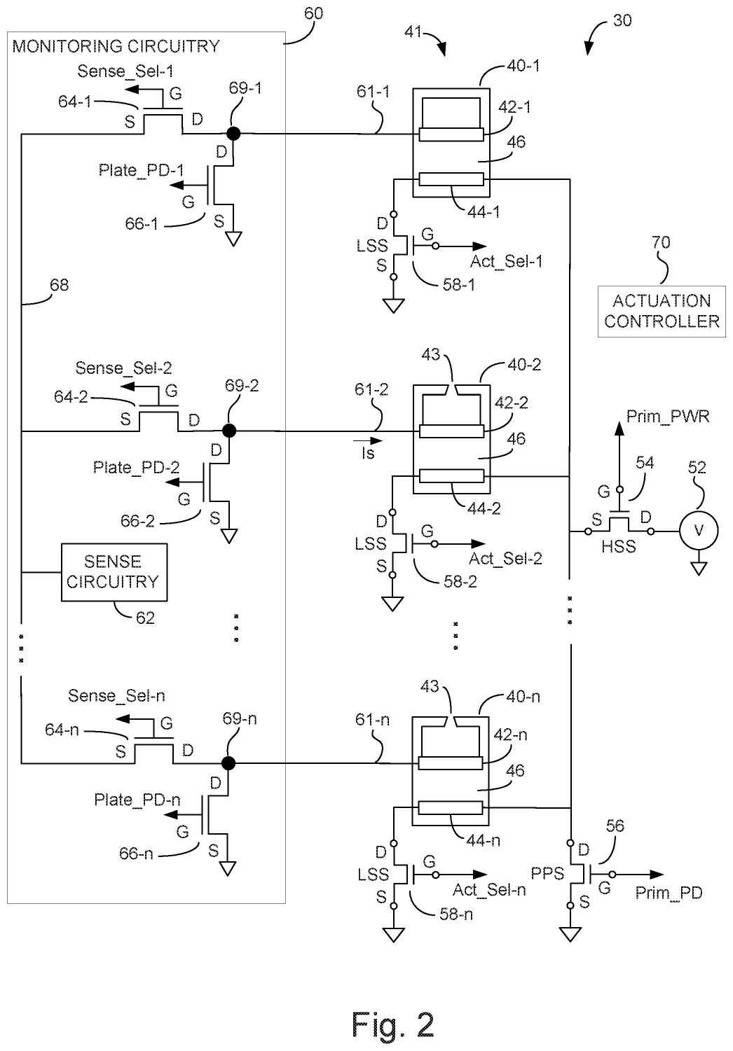

FIG. 2 is a block and schematic diagram generally illustrating portions of fluidic die 30, according to one example. In one example, the plurality of fluid actuators 44 is arranged to form a primitive 41, where a portion of the fluid actuators 44 may be arranged as part of a nozzle where the corresponding fluid chamber 40 is in fluidic communication with a nozzle orifice 43 (such as illustrated by fluid chambers 40-2 and 40-n, for instance), and another portion may be arranged as part of a pump (such illustrated by fluid chamber 40-1, for instance). In one example, each cavitation plate 42 is disposed within the corresponding fluid chamber 40 so as to be exposed to an interior thereof and which may be in contact with a fluid 45 if present therein (e.g., ink).

In one example, monitoring circuitry 60 includes sense circuitry 62 and, for each fluid chamber 40, includes a select transistor 64 (illustrated as select transistors 64-1 to 64-n) and a pulldown transistor 66 (illustrated at pulldown transistors 66-1 to 66-n), with each having a gate (G), a source (S), and a drain (D). In one example, each select and pulldown transistor 64 and 66 is a MOSFET (e.g., NMOS, PMOS). In one arrangement, the drain region (D) of each pair of select and pulldown transistors 64 and 66 is connected to a corresponding sense node 69 (illustrated as sense nodes 69-1 to 69-n), with sense node 69 connected to the cavitation plate 42 of a corresponding fluid chamber 40 by connection element 61. In one example, the source (S) of each select transistor 64 is connected to sense circuitry 62 via a sense line 68, and the source (S) of each pulldown transistor 66 is connect to a reference voltage (e.g., ground). In one example arrangement, as illustrated, monitoring circuitry 62 further includes a sense select signal (Sense_Sel) to the gate of each select FET 60 (illustrated as sense select signals Sense_Sel-1 to Sense_Sel-n), and a plate pulldown signal (Plate_PD) to the gate of each pulldown FET 62 (illustrated as plate pulldown signals Plate_PD-1 to Plate_PD-n).

In example, when actuators 44-1 to 44-n of primitive 41 are inactive or idle (i.e., no firing event), an actuation controller 70 maintains HSS 54 and each LSS 58-1 to 58-2 in an “open” position, and maintains primitive pulldown switch (PPS) 56 in a “closed” position to keep power node 50 at a known reference voltage (e.g., 0 V). In one example, during a firing event, actuation controller 70 opens PPS 56 (via primitive pulldown signal, Prim_PD), closes HSS 54 to couple power source 52 to power node 50 (via primitive power signal, Prim_PWR), and closes a selected one of the LSSs 58 corresponding to the fluid chamber 40 which is to be activated (via actuation select signals, Act_Sel-1 to Act_Sel-n). After the selected fluid actuator 44 has been fired, actuation controller 70 opens the corresponding LSS 58, opens HSS 54, and closes PPS 56.

In one example, monitoring or sensing operations of fluid chambers 40 of primitive 41 occur when actuators 44-1 to 44-n of primitive 41 are inactive. In one example, a sensing operation occurs for a given fluid chamber 40 shortly after firing of the corresponding fluid actuator 44 has been completed. In one example, during a sensing operation (e.g., a DBD sense operation), sense circuitry 62 connects a cavitation plate 42 of one selected fluid chamber 40 at a time to sense line 68 by closing the select transistor 64 corresponding to the selected fluid chamber 40 via the Sense_Sel signals, and by disabling the corresponding pulldown transistor 66 via Plate_PD signals. In one example, sense circuitry 62, via interface with actuator controller 70, opens PPS 56 so that fluid actuator 44 corresponding to the selected fluid chamber 40 is floating (i.e., isolated from any electrical potential), and then injects a sense current (e.g., a current pulse) through the selected fluid chamber 40 from cavitation plate 42 to a ground point and determines an impedance based on a resulting voltage on sense node 69 to evaluate an operating condition of the selected fluid chamber 40. Upon completion of the sensing operation, according to one example, sense circuitry 62 closes PPS 56, opens the select transistor 64, and closes the pulldown transistor 66.

In one example, sense circuitry 62 interfaces with actuation controller 70 to control PPS 56 to coordinate firing and sensing operations. In one example, sense circuitry 62 provides indication to actuation controller 70 when a sensing operation is to be performed and, in response, actuation controller 70 opens PPS 56. Upon indication from sense circuitry 62 that the sensing operation is complete, actuation controller 70 closed PPS 56.

As described above, by opening PS 56 so that fluid actuators 44 are “floating” during a monitoring operation of a selected fluid chamber 40 by monitoring circuitry 60, a parasitic capacitance that would otherwise be formed between the cavitation plate 42 of the selected fluid chamber 40 and the corresponding fluid actuator 44 is eliminated. By eliminating such parasitic capacitance, a variable impedance representing an impedance of the selected fluid chamber 40 forms a greater portion of an overall impedance measured by monitoring circuitry 60 and improves an effectiveness and accuracy in determining an operating condition of the selected fluid chamber 40

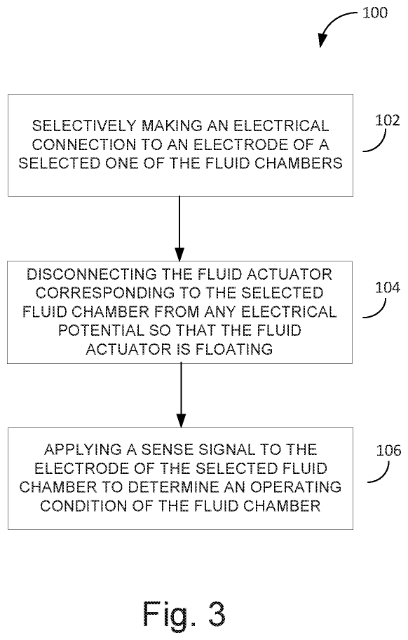

FIG. 3 is flow diagram 100 generally illustrating a method for monitoring an operating condition of a group of fluid chambers of a fluidic die, each fluid chamber including an electrode exposed to an interior thereof and having a corresponding fluid actuator, such as monitoring circuitry 60 of FIG. 1 monitoring an operating condition of the group of fluid chambers 40-1 to 40-n, with each fluid chamber including a correspond electrode (e.g., cavitation plate) 42-1 to 42-n, and each having a corresponding fluid actuator 44-1 to 44-n.

At 102, the method including selectively making an electrical connection to the electrode of a selected one of the fluid chambers, such as monitoring circuitry 60 selectively making an electrical connection to a selected one of the fluid chambers 40-1 to 40-n via a corresponding connection element 61-1 to 61-n. In one example, with reference to FIG. 2, an electrical connection is made to the cavitation plate 44 of a selected one of the fluid chambers 40-1 to 40-n via a corresponding select switch 64-1 to 64-n.

At 104, the method includes disconnecting the fluid actuator corresponding to the selected fluid chamber from any electrical potential so that the fluid actuator is floating, such as monitoring circuitry 60 of FIGS. 1 and 2 opening pulldown switch 56 to disconnect power node 50 from a reference voltage, as HSS 54 and each LSS 58-1 to 58-n are open while fluid actuators 44-1 to 44-n are idle during a sense operation. In one example, PPS 56 is briefly enabled (such as by sense controller 62) to place power node 50 at a known reference voltage prior to application of a sense current (see 106 below) to an electrode.

At 106, the method includes applying a sense signal to the electrode of the selected fluid chamber to determine an operating condition of the selected fluid chamber, such as monitoring circuitry 60 of FIGS. 1 and 2 applying a sense current, I_{S}, to the electrode of the selected fluid chamber 40, such as fluid chamber 40-2 in FIGS. 1 and 2.

In one example, the method further includes determining an operation condition of the selected fluid chamber 40 based on a response of the fluid chamber to the applied sense signal. In one example, the method includes closing the pulldown switch to return the power node to the reference voltage after the response of the selected fluid chamber 40 to the applied sense signal has been determined.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A fluidic die comprising:
a high-side switch to selectively couple a power node to a power source;
a pulldown switch to selectively couple the power node to a first reference voltage;
a group of fluid actuators, each fluid actuator connected to the power node and each having a corresponding low-side switch to selectively couple the fluid actuator to a second reference voltage;
a group of fluid chambers, each including an electrode exposed to an interior of the fluid chamber, and each corresponding to a different one of the fluid actuators; and
monitoring circuitry to monitor a condition of each fluid chamber, during a monitoring operation, with the high-side switch and each low-side switch open, the monitoring circuit to:
connect the electrode of a selected one of the fluid chambers; and
open the pulldown switch so that the fluid actuators are floating.

2. The fluidic die of claim 1, the monitoring circuit to apply a sense signal to the electrode while the pulldown switch is open.

3. The fluidic die of claim 1, the monitoring circuitry to close the pulldown switch upon completion of the monitoring operation.

4. The fluidic die of claim 1, the monitoring circuitry to:
close the pulldown switch to pull the power node and each fluid actuator to the first reference voltage during a first portion of the monitoring operation; and
open the pulldown switch during a second portion of the monitoring operation.

5. The fluidic die of claim 4, the monitoring circuitry to:
apply a sense signal to the selected one of the electrodes during the second portion of the monitoring operation.

6. The fluidic die of claim 5, during the second portion of monitoring operation, the monitoring circuitry to determine an operating condition of the selected one of the fluid chambers based on a response of the selected one of the fluid chambers to the sense signal.

7. The fluidic die of claim 5, the sense signal being one of a current pulse and a voltage.

8. The fluidic die of claim 5, the monitoring circuitry to close the pulldown switch upon completion of the second portion of the monitoring operation.

9. The fluidic die of claim 1, the first reference voltage equal to the second reference voltage.

10. A fluidic die comprising:
a power node connected to a power source via a high-side switch and to a first reference voltage via a pulldown switch;
a group of fluid chambers, each including an electrode exposed to an interior thereof, and each having a corresponding fluid actuator, with each fluid actuator connected to the power node at a one end and connected at a second end to a second reference voltage via a corresponding low-side switch; and
monitoring circuitry including:
a select transistor corresponding to each fluid chamber; and
sense circuitry, during a sense operation, with the high-side switch and each low-side switch open, the sense circuitry to:
connect to the electrode of a selected one of the fluid chambers via the corresponding select switch;
open the pulldown switch to disconnect the power node from the first reference voltage; and
apply a sense signal to the electrode of the selected fluid chamber via the corresponding select switch to determine an operating condition of the selected fluid chamber.

11. The fluidic die of claim 10, the fluid actuators corresponding to the group of fluid chambers arranged to form a primitive.

12. The fluidic die of claim 10, when the fluid actuators corresponding to the group of fluid chambers are idle, the high-side switch and each low-side side being open and the pulldown switch being closed.

13. A method for monitoring an operating condition of a group of fluid chambers on a fluidic die, each fluid chamber including an electrode exposed to an interior thereof and having a corresponding fluid actuator, the method including:
selectively making an electrical connection to the electrode of a selected one of the fluid chambers;
disconnecting the fluid actuator corresponding to the selected fluid chamber from any electrical potential so that the fluid actuator is floating; and
applying a sense signal to the electrode of the selected fluid chamber to determine an operating condition of the selected fluid chamber.

14. The method of claim 13, each fluid actuator connected to a power node at a first end and to a first reference voltage at a second end via a corresponding low-side switch, the power node connected to a power source via a high-side switch and to a second reference voltage via a pulldown switch, with the high-side switch and each low-side switch in an open position, disconnecting the fluid actuator of the selected fluid chamber includes opening the pulldown switch.
